(19) United States
(12) Patent Application Publication
(10) Pub. No.: US 2018/0207561 A1
(43) Pub. Date: Jul. 26, 2018

(54) WATER FILTER FAUCET HAVING FILTER LIFE DETERMINING FUNCTIONALITY

(71) Applicant: ZHONGSHAN FILTERPRO ENVIRONMENTAL PROTECTION TECHNOLOGY, LLC, Zhongshan City, Guangdong (CN)

(72) Inventors: BingBing LI, Zhongshan City (CN); Li JIANG, Zhongshan City (CN); Zhenlong HUANG, Zhongshan City (CN); Wenfeng DENG, Zhongshan City (CN)

(73) Assignee: ZHONGSHAN FILTERPRO ENVIRONMENTAL PROTECTION TECHNOLOGY, LLC, Zhongshan City, Guangdong (CN)

(21) Appl. No.: 15/546,896

(22) PCT Filed: Sep. 1, 2016
(86) PCT No.: PCT/CN2016/097815

§ 371 Date: Jul. 27, 2017

(30) Foreign Application Priority Data
Oct. 13, 2015 (CN) 201510656867.7

(51) Int. Cl. B01D 35/143; B01D 35/04; C02F 1/00

(52) U.S. Cl. CPC B01D 35/1435; B01D 35/046; C02F 2307/06; C02F 1/008; C02F 2209/445; C02F 1/003

(57) ABSTRACT

A water filter faucet having a filter element life determining functionality comprises a faucet body having a valve disposed therein. A rotatable handle is arranged on the faucet body and configured to control an operation of the valve. A monitoring device is arranged on the rotatable handle and electrically connected to a control circuit configured to receive a monitoring signal from the monitoring device and count a time. The control circuit is connected to a warning device configured to warn of that the service life of the filter element is to an end.

### TECHNICAL FIELD

The disclosure relates to a water filter faucet, and more particularly, to a water filter faucet having a filter element life determining functionality.

### BACKGROUND

With the social development and ever-worsening living environment, people pay more and more attention to safety and sanitation of drinking water and used water, with a water filter faucet capable of filtering water being came into being.

The existing water filter faucet mainly relies on the filter element to filter the water running through the faucet, so as to achieve the water filter function. The filter element will continuously absorb various impurities when filtering the used water. When the number of impurities absorbed by the filter element reaches the limit, the service life of the filter element also reaches the limit, so that the filter element cannot filter the used water, and a new filter element needs to be replaced at this time.

But whether or not the service life of the filter element of the existing water filter faucet reaches the limit is generally estimated by the user based on the use condition, sometimes the service life of the filter element does not reach the limit, the user replaces the new filter element due to error estimation, resulting in waste of resources, and increasing the use cost of the user. Sometimes the filter element life has already reached the limit, the user thinks that the service life of the filter element has not yet reaches the limit and continues to use the filter element, but such filter element cannot filter the water, and then the user drinks or uses some dirty water, which brings certain danger to the health of the user.

### SUMMARY OF THE INVENTION

In order to solve the above problems, the disclosure aims at providing a water filter faucet having a filter element life determining functionality and capable of warning a user of that the service life of the filter element is to an end.

In order to solve the technical problems, the disclosure employs the technical solutions as follows.

A water filter faucet having a filter element life determining functionality comprises a faucet body having a valve disposed therein to control on-off of a water route therein, a rotatable handle is further arranged on the faucet body and configured to control an operation of the valve simultaneously, wherein a monitoring device for monitoring a rotating situation of the rotatable handle is arranged on the rotatable handle and is electrically connected to a control circuit configured to receive a monitoring signal from the monitoring device and count a time, and the control circuit is connected to a warning device configured to warn of that the service life of the filter element is to an end.

As an improvement of the above technical solution, the monitoring device is a gravity switch fixedly mounted on the rotatable handle.

As an improvement of the above technical solution, the monitoring device comprises a through-beam photoelectric sensor and a baffle, one of the through-beam photoelectric sensor and the baffle is arranged on the faucet body, while the other is arranged on the rotatable handle.

In the disclosure, the warning device is an LED lamp.

Preferably, the warning device is a buzzer.

Further, the control circuit is integrated on a circuit board, and a mounting base is arranged on the rotatable handle and is opened with a containing cavity having an opening, and the circuit board is arranged in the containing cavity of the mounting base

Still further, a power source for supplying power to the circuit board is further arranged in the containing cavity.

As one preferred embodiment of the disclosure, a power socket is further arranged in the containing cavity, the power source is fixedly arranged on the power socket, and the circuit board is also fixedly arranged on the power socket simultaneously.

Further, a sealing cap for sealing the opening is further arranged at the opening of the containing cavity.

The disclosure has the advantageous effects that: since the disclosure is provided with the monitoring device for monitoring the rotating situation of the rotatable handle on the faucet body, the monitoring device is connected with a control circuit simultaneously, when the monitoring device monitors that the rotatable handle rotates and controls the valve to connect the water route, the used water flows through the filter element, the control circuit counts a time; when the monitoring device monitors the rotation of the rotatable handle and controls the valve to disconnect the water route, no used water flows through the filter element at this time, the control circuit stop counting the time; when the monitoring device monitors that the rotatable handle is rotated again and the valve is connected with the water route again, the control circuit counts the time again, it is circulated in such manner again and again, the control circuit counts the time and computes the working time of the filter element. When the working time of the filter element reaches the set life limit, the control circuit warns the user that the service life of the filter element reaches the limit by the warning device and a new filter element needs to be replaced.

By adopting the monitoring device and the control circuit to compute the service life of the filter element for the water filter faucet of the disclosure, a time limit when the service life is terminated can be computed, a traditional estimated mode is abandoned to compute the service life of the filter element, which can prevent the filter element from being replaced too soon, reducing a cost of using the water filter faucet, while preventing a user from using an unserviceable filter element scrap, ensuring water hygiene of a user.

### BRIEF DESCRIPTION OF THE DRAWINGS

The disclosure will be further described in details hereinafter with reference to the drawings and the specific embodiments.

FIG. 1 is a schematic diagram of an appearance structure of a preferred embodiment of the disclosure;

FIG. 2 is a schematic diagram for decomposition of a local structure of a preferred embodiment of the disclosure;

FIG. 3 is a schematic diagram for a state of a sealing cap separated from an opening of a containing cavity in one preferred embodiment of the disclosure;

FIG. 4 is a schematic diagram of an assembly structure of a circuit board, a power source and a power socket in one preferred embodiment of the disclosure;

FIG. 5 is a schematic diagram of the assembly structure of the circuit board, the power source and the power socket from other perspective in one preferred embodiment of the disclosure;

FIG. 6 is an amplified diagram at A in FIG. 2; and

FIG. 7 is an amplified diagram at B in FIG. 3.

### DETAILED DESCRIPTION OF THE EMBODIMENTS

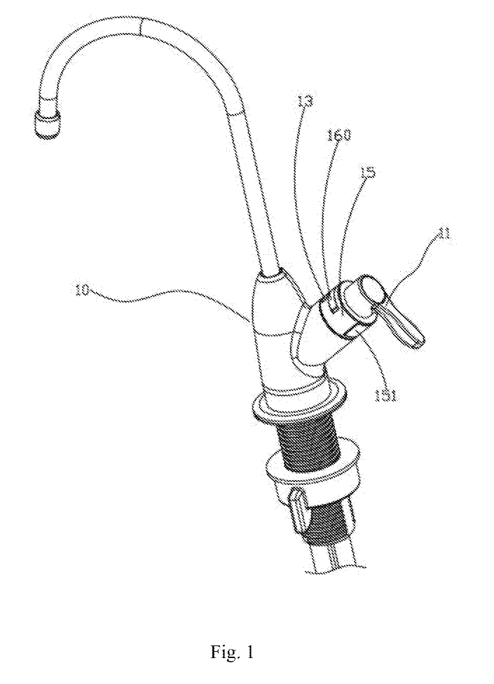

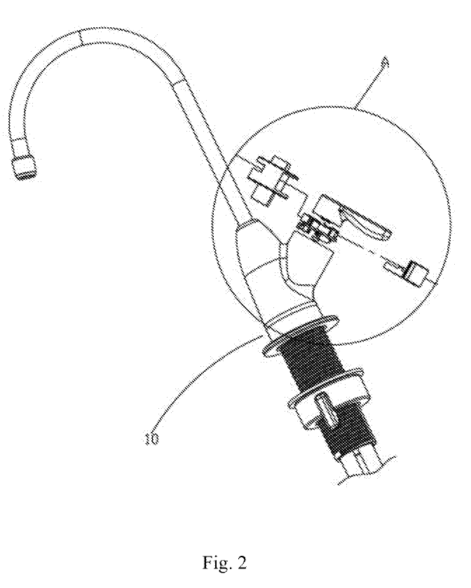

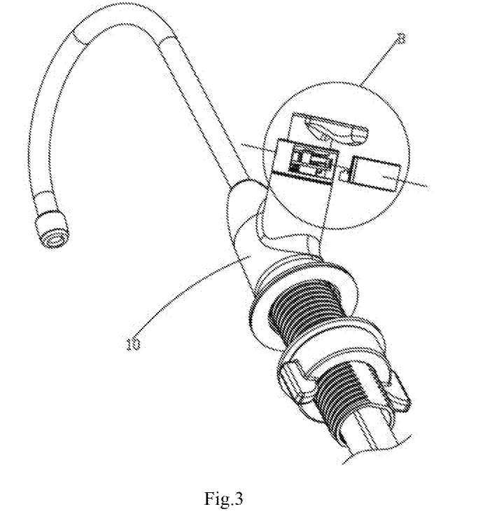

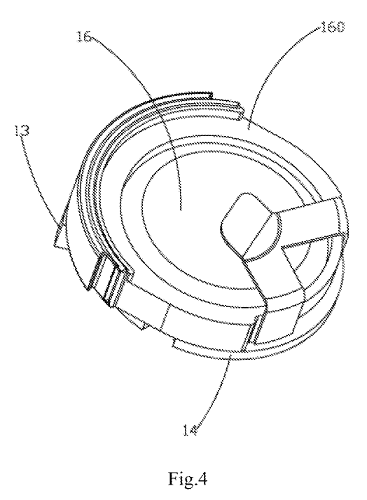

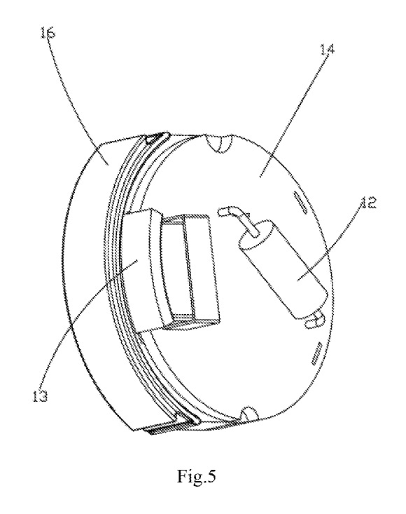

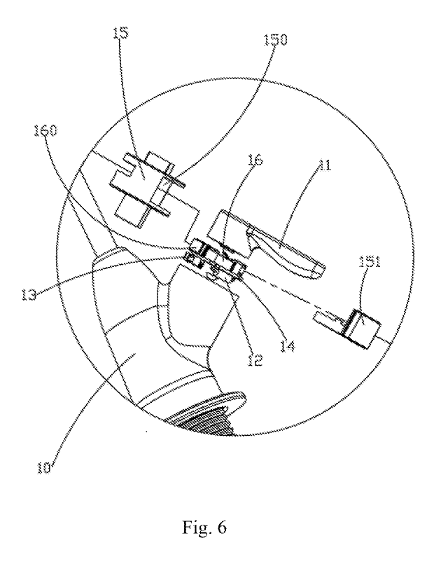

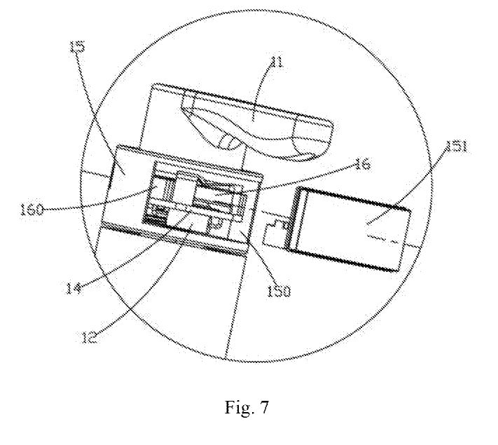

Referring to FIG. 1 to FIG. 7, a water filter faucet having a filter element life determining functionality comprises a faucet body 10 having a valve disposed therein to control connection-disconnection of a water route therein, a rotatable handle 11 is further arranged on the faucet body 10 and configured to control an operation of the valve simultaneously, wherein a monitoring device 12 for monitoring a rotating situation of the rotatable handle 11 is arranged on the rotatable handle 11 and is electrically connected to a control circuit configured to receive a monitoring signal from the monitoring device 12 and count a time, and the control circuit is connected to a warning device 13 configured to warn of that the service life of the filter element is to an end.

Since the disclosure is provided with the monitoring device 12 for monitoring the rotating situation of the rotatable handle 11 on the faucet body 10, the monitoring device 12 is connected with a control circuit simultaneously, when the monitoring device 12 monitors that the rotatable handle 11 rotates and controls the valve to connect the water route, the used water flows through the filter element, the filter element works and filters the used water at this time, the control circuit counts a time and keeps a record of a working time of the filter element. When the monitoring device 12 monitors the reverse rotation of the rotatable handle 11 and controls the valve to disconnect the water route, no used water flows through the filter element at this time, the control circuit stop counting the time, and does not keep a record of the working time of the filter element. When the monitoring device monitors that the rotatable handle 11 is rotated again and the valve is connected with the water route again, the control circuit counts the time again, it is circulated in such manner again and again, the control circuit counts the time and computes the working time of the filter element. When the working time of the filter element reaches the set life limit, the control circuit warns the user that the service life of the filter element reaches the limit by the warning device 13 and a new filter element needs to be replaced.

In order to make the surface of the water filter faucet of the disclosure more concise and be able to protect the control circuit, at this point, as a preferred embodiment of the disclosure, the control circuit is integrated on a circuit board 14, a mounting base 15 is arranged on the rotatable handle 11 and is opened with a containing cavity 150 having an opening, and the circuit board 14 is arranged in the containing cavity 150 of the mounting base 15, further preferably, the mounting base 15 is arranged between the faucet body 10 and the rotatable handle 11, and the rotatable handle 11, during rotation, can drive the mounting base 15 to rotate synchronously.

In order to enable the control circuit to be able to work normally, and not to be connected with an outside circuit as well, preferably, a power source 16 for supplying power to the circuit board 14 is further arranged in the containing cavity 150, at this point, the power supply 16 can be a dry battery or a lithium battery, and of course, can also be lead-acid battery or the like.

Further, in order to place the battery 16 and the circuit board 15 better, at this point, as the preferred embodiment of the disclosure, a power socket 160 is further arranged in the containing cavity 150, the power source 16 is fixedly arranged on the power socket 160, and the circuit board 14 is also fixedly arranged on the power socket 160 simultaneously, further preferably, the power source 160 is arranged on an upper surface of the power socket 160, while the circuit board 14 is arranged on a lower surface of the power socket 160.

In order to protect members located in the containing cavity 150, preferably, a sealing cap 151 for sealing the opening is further arranged at the opening of the containing cavity 150, further preferably, the sealing cap 151 is preferably made of rubber, and then, the sealing cap 151 can seal the containing cavity 150 well, which cannot only protect the members located in the containing cavity 150, but also can prevent water from entering the containing cavity 150 to damage the circuit board 14, the monitoring device 12 and the power source 16, etc., and at the same time, the sealing cap 151 arranged at the opening of the containing cavity 150 can avoid the members located in the containing cavity 150 from being exposed, and then the surface of the water filter faucet of the disclosure is made more concise.

At this point, in order to enable the monitoring device 13 to be able to monitor the rotating situation of the rotatable handle 11 more accurately, the monitoring device 12 is a gravity switch fixedly mounted on the rotatable handle 11, as the preferred embodiment of the disclosure, the gravity switch is arranged on the circuit board 14. When the rotating handle 11 drives the gravity switch to positively rotate, the gravity switch connects a circuit, and then inputs a monitored signal that the rotatable handle 11 rotates into the control circuit, and the control circuit counts a time; when reversely rotating the rotatable handle 11, the gravity switch reversely rotates and disconnects the circuit simultaneously, the control circuit does not receives a detection signal sent from the gravity switch at this time, and the control circuit stops counting the time.

In the disclosure, the above-mentioned monitoring device 12 can also adopts the following structure besides the gravity switch. The monitoring device 12 comprises a through-beam photoelectric sensor and a baffle, one of the through-beam photoelectric sensor and the baffle is arranged on the faucet body 10, while the other is arranged on the rotatable handle 11. At this point, as one preferred embodiment of the disclosure: when the water filter faucet is closed, the baffle is locate between the through-beam photoelectric sensors and blocks a photoelectric signal of the through-beam photoelectric sensor, by this time, the through-beam photoelectric sensor inputs a signal of a blocked water route of the faucet into the control circuit, the control circuit does not count a time. When rotating the rotatable handle 11 to drive the baffle or the through-beam photoelectric sensor to rotate, the baffle and the through-beam photoelectric sensor are mutually staggered, by this time, the baffle does not block the photoelectric signal of the through-beam photoelectric sensor any more, the through-beam photoelectric sensor inputs a signal of a connected water route of the faucet into the control circuit, by this time, the control circuit counts the time and computes the service life of the filter element. When reversely rotating the rotatable handle 11, the rotatable handle 11 drives the baffle or the through-beam photoelectric sensor to rotate reversely, by this time, the baffle is located between the through-beam photoelectric sensors again and blocks the photoelectric signal of the through-beam photoelectric sensor, and then the through-beam photoelectric sensor sends a signal of the blocked water route of the faucet, the control circuit stops counting the time, which is circulated in such way.

In order to enable the water filter faucet of the disclosure to be able to warn the user of that the service life of the filter element is to an end better, preferably, the warning device 13 is an LED lamp. When the control circuit computes the service life of the filter element is to an end by counting the time, the control circuit can drive the LED lamp to send out the light set to warn the user of needing to replace a new filter element. Of course, the above-mentioned warning device 13 can also adopt the following structure besides the LED lamp: the warning device 13 is a buzzer. When the control circuit needs to warn the user of replacing the new filter element, the control circuit can drive the buzzer to make a sound, and then warns the user of replacing the filter element. The above-mentioned warning device 13 can also be the combination of the LED lamp and the buzzer.

The above description is merely the preferred mode of execution of the disclosure, and any technical solution achieving the object of the disclosure via the basically same means shall all fall within the protection scope of the disclosure.

1. A water filter faucet having a filter element life determining functionality, comprising a faucet body with a valve disposed therein to control on-off of a water route therein, and a rotatable handle further arranged on the faucet body and configured to control an operation of the valve simultaneously, wherein a monitoring device for monitoring a rotating situation of the rotatable handle is arranged on the rotatable handle and is electrically connected to a control circuit configured to receive a monitoring signal from the monitoring device and count a time, and wherein the control circuit is connected to a warning device configured to warn of that the service life of the filter element is to an end.

2. The water filter faucet having a filter element life determining functionality according to claim 1, wherein the monitoring device is a gravity switch fixedly mounted on the rotatable handle.

3. The water filter faucet having a filter element life determining functionality according to claim 1, wherein the warning device is an LED lamp.

4. The water filter faucet having a filter element life determining functionality according to claim 1, wherein the warning device is a buzzer.

5. The water filter faucet having a filter element life determining functionality according to claim 1, wherein the control circuit is integrated on a circuit board, a mounting base is arranged on the rotatable handle and is opened with a containing cavity having an opening, and the circuit board is arranged in the containing cavity of the mounting base.

6. The water filter faucet having a filter element life determining functionality according to claim 5, wherein a power source for supplying power to the circuit board is further arranged in the containing cavity.

7. The water filter faucet having a filter element life determining functionality according to claim 6, wherein a power socket is further arranged in the containing cavity, the power source is fixedly arranged on the power socket, and the circuit board is also fixedly arranged on the power socket simultaneously.

8. The water filter faucet having a filter element life determining functionality according to claim 5, wherein a sealing cap for sealing the opening is further arranged at the opening of the containing cavity.

9. The water filter faucet having a filter element life determining functionality according to claim 6, wherein a sealing cap for sealing the opening is further arranged at the opening of the containing cavity.

10. The water filter faucet having a filter element life determining functionality according to claim 7, wherein a sealing cap for sealing the opening is further arranged at the opening of the containing cavity.
